(19) United States
(12) Patent Application Publication
(10) Pub. No.: US 2019/0383070 A1
(43) Pub. Date: Dec. 19, 2019

(54) LOCKER, LOCKER DOOR ASSEMBLY, AND HASP ASSEMBLY FOR A LOCKER

(71) Applicant: Major Partitions Ltd., Candiac (CA)

(72) Inventor: Thomas Marchl, Candiac (CA)

(21) Appl. No.: 16/008,196

(22) Filed: Jun. 14, 2018

(51) Int. Cl. E05C 19/08; E05B 67/38; E05B 65/02

(52) U.S. Cl. CPC E05C 19/08; E05B 65/025; E05B 67/383

(57) ABSTRACT

A hasp assembly for selectively securing a door, a locker door assembly, and a door. The hasp assembly includes a first hasp connecting to the door and defining a first hasp aperture; a second hasp connecting to a surface adjacent the door and defining a second hasp aperture; and a guard member fixedly connected to the first hasp and defining first and second guard apertures, the first guard aperture and the first hasp aperture being at least partially aligned, the guard member extending along a portion of an exterior side of the first hasp, when the hasp assembly is installed and the door is in a closed position: the apertures being at least partially aligned for receiving a locking apparatus therethrough and the guard member extending at least partially over a first portion defining the first hasp aperture and a second portion defining the second hasp aperture.

### FIELD OF TECHNOLOGY

The present technology generally relates to the field of assemblies for selectively securing doors and lockers, and more specifically to hasp assemblies, locker door assemblies, and lockers with hasp assemblies.

### BACKGROUND

Lockers are used to store and protect goods, for example in large shared common spaces such as a garage or basement of an apartment complex. Such lockers generally have some sort of hasp assembly, through which a combination lock or padlock is passed to secure the door shut.

As combination locks and padlocks become stronger and better designed, those desiring to illicitly access the interior of the locker may turn to the locker itself. In some situations, rather than attack the lock, thieves could attempt to cut through the hasp assembly.

To address this challenge, one solution is to construct hasp assemblies from thicker and/or stronger material to impede breaking or cutting the hasp assemblies. From a manufacturing perspective, however, this may not be optimal, as cutting and bending thicker and/or stronger materials generally requires specialized or additional machinery. Further, such materials can be more expensive in both handling and material costs.

There is therefore a desire for structures for receiving locks, to securely close lockers and similar structures, without at least some of the inconveniences of the above.

### SUMMARY

It is an object of the present technology to ameliorate at least some of the inconveniences present in the prior art.

According to a first broad aspect of the present technology, there is provided a hasp assembly for selectively securing a door. The hasp assembly includes through members: a hasp connected to the door, a hasp connected to a surface adjacent to the door, and a guard member that extends around the two hasps when the door is closed. The guard member and the two hasps are made from the same material, so that the same machinery can be used to cut and bend all three portions. By adding the guard member over the hasps, the hasp assembly has a double thickness of materials on the portion of the assembly extending away from the locker, without necessitating specialized machinery or more costly material. Additionally, the guard member covers at least the front side of the gap between the hasps, further impeding access to the lock securing the locker.

According to a first broad aspect of the present technology, there is provided a hasp assembly for selectively securing a door. The hasp assembly includes a first hasp adapted to connect to the door, the first hasp defining a first hasp aperture; a second hasp adapted to connect to a surface adjacent the door, the second hasp defining a second hasp aperture; and a guard member fixedly connected to the first hasp, the guard member defining a first guard aperture and a second guard aperture, the first guard aperture and the first hasp aperture being at least partially aligned, the guard member extending along at least a portion of an exterior side of the first hasp, the first hasp aperture, the second hasp aperture, the first guard aperture, and the second guard aperture being at least partially aligned for receiving a locking apparatus therethrough when the hasp assembly is installed and the door is in a closed position, the guard member extending at least partially over a first portion of the first hasp defining the first hasp aperture and a second portion of the second hasp defining the second hasp aperture when the hasp assembly is installed and the door is in the closed position.

In some embodiments, the first hasp and the second hasp are L-shaped hasps; and the first and second hasps are disposed in mirror-image arrangements.

In some embodiments, the first hasp further includes a third portion adapted to connect to the door, the first portion extending forward from the third portion; and the second hasp further includes a fourth portion adapted to connect to the surface, the second portion extending forward from the fourth portion, the first portion and the second portion being generally parallel when the hasp assembly is installed and the door is in the closed position.

In some embodiments, when the door is in the closed position, the guard member extends: along at least a majority of an exterior side of the first portion; around a forward side of a gap between the first portion and the second portion; and along at least a majority of an exterior side of the second portion.

In some embodiments, when the door is in the closed position, the guard member extends: along at least a majority of an exterior side of the first portion; over a top side of a gap between the first portion and the second portion; and along at least a majority of an exterior side of the second portion.

In some embodiments, the first hasp, the second hasp, and the guard member are made of a same material.

In some embodiments, the first hasp, the second hasp, and the guard member are made from material having a same thickness.

In some embodiments, the guard member is welded to the first hasp.

In some embodiments, the guard member is generally U-shaped; straight portions of the U-shape overlap the first and second hasps when the hasp assembly is installed and the door is in the closed position; and a central portion of the U-shape covers a gap between the first hasp and the second hasp when the hasp assembly is installed and the door is in the closed position.

In some embodiments, a width of a first gap defined between the first portion and the second portion is greater than a width of a second gap defined between the second portion and a portion of the guard member overlapping the second portion when the door is closed.

According to another broad aspect of the present technology, there is provided a locker door assembly for installing on a locker. The locker door assembly includes a door selectively moveable between at least a closed position and an opened position; and a hasp assembly according to any of the above embodiments for selectively securing the door in the closed position.

According to yet another broad aspect of the present technology, there is provided a locker door assembly for installing on a locker. The locker door assembly includes a door selectively moveable between at least a closed position and an opened position; and a hasp assembly for selectively securing the door in the closed position. The hasp assembly includes a first hasp connected to the door, the first hasp defining a first hasp aperture; a second hasp adapted to connect to a surface adjacent the door, the second hasp defining a second hasp aperture; and a guard member fixedly connected to the first hasp, the guard member defining a first guard aperture and a second guard aperture, the first guard aperture and the first hasp aperture being at least partially aligned, the guard member extending along at least a portion of an exterior side of the first hasp, the first hasp aperture, the second hasp aperture, the first guard aperture, and the second guard aperture being at least partially aligned for receiving a locking apparatus therethrough when the hasp assembly is installed and the door is in a closed position, the guard member extending at least partially over a first portion of the first hasp defining the first hasp aperture and a second portion of the second hasp defining the second hasp aperture when the hasp assembly is installed and the door is in the closed position.

In some embodiments, the first hasp is welded to the door; and the second hasp is adapted to be bolted to the surface.

In some embodiments, the guard member is generally U-shaped; straight portions of the U-shape overlap the first and second hasps when the hasp assembly is installed and the door is in the closed position; and a central portion of the U-shape covers a gap between the first hasp and the second hasp when the hasp assembly is installed and the door is in the closed position.

According to yet another broad aspect of the present technology, there is provided a locker including a plurality of walls; a door pivotably connected to a wall of the plurality of walls, the door being selectively moveable between at least a closed position and an opened position; and a hasp assembly for selectively securing the door in the closed position. The hasp assembly includes a first hasp connected to the door, the first hasp defining a first hasp aperture; a second hasp connected to a surface of the locker adjacent the door, the second hasp defining a second hasp aperture; and a guard member fixedly connected to the first hasp, the guard member defining a first guard aperture and a second guard aperture, the first guard aperture and the first hasp aperture being at least partially aligned, the guard member extending along at least a portion of an exterior side of the first hasp, the first hasp aperture, the second hasp aperture, the first guard aperture, and the second guard aperture being at least partially aligned for receiving a locking apparatus therethrough when the door is in a closed position, the guard member extending at least partially over a first portion of the first hasp defining the first hasp aperture and a second portion of the second hasp defining the second hasp aperture when the door is in the closed position.

In some embodiments, the first hasp is welded to the door; and the second hasp is bolted to the surface of the locker adjacent the door.

In some embodiments, the first hasp further includes a third portion connected to the door, the first portion extending forward from the third portion; and the second hasp further includes a fourth portion connected to the surface of the locker adjacent the door, the second portion extending forward from the fourth portion, the first portion and the second portion being generally parallel when the door is in the closed position.

In some embodiments, when the door is in the closed position, the guard member extends: along at least a majority of an exterior side of the first portion; around a forward side of a gap between the first portion and the second portion; and along at least a majority of an exterior side of the second portion.

In some embodiments, when the door is in the closed position, the guard member extends: along at least a majority of an exterior side of the first portion; over a top side of a gap between the first portion and the second portion; and along at least a majority of an exterior side of the second portion.

In some embodiments, the door includes: a door frame, and mesh material connected to the door frame; the wall of the plurality of walls includes: a wall frame including the surface of the locker adjacent the door, and mesh material connected to the wall frame; the first hasp is connected to the door frame; and the second hasp is connected to the wall frame.

In some embodiments, the guard member is welded to the first hasp.

In some embodiments, the guard member is generally U-shaped; straight portions of the U-shape overlap the first and second hasps when the door is in the closed position; and a central portion of the U-shape covers a gap between the first hasp and the second hasp when the door is in the closed position.

According to yet another broad aspect of the present technology, there is provided a locker including a plurality of walls; a door pivotally connected to a wall of the plurality of walls, the door being selectively moveable between at least a closed position and an opened position; and a hasp assembly according to any of the above embodiments for selectively securing the door in the closed position.

According to yet another broad aspect of the present technology, there is provided a locker including a plurality of walls; and the locker door assembly according to any of the above embodiments, the door being pivotally connected to a wall of the plurality of walls.

For purposes of this application, terms related to spatial orientation are defined with respect to the standard operational orientation of the locker, and the hasp assembly as installed on the corresponding locker. Specifically, vertical is meant to represent a direction generally orthogonal to the ground upon which the locker rests when oriented in its standard operational orientation.

For purposes of this application, the term “locker” refers generally to a structure meant to securely receive, store, and/or protect objects placed therein.

It is contemplated that the hasp assemblies of the present technology described herein could be utilized to secure structures other than lockers. Some other such structures could include, but are not limited to: cabinets, cages, sheds, and partitions.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, front, left side perspective view of a locker according to the present technology, the locker having a lock attached thereto;

FIG. 2 is a close-up, front side elevation view of a portion of the locker and the lock of FIG. 1;

FIG. 3 is a top, front, left side perspective view of a hasp assembly of the locker of FIG. 1, the hasp assembly being shown in isolation;

FIG. 4 is a top plan view of the hasp assembly of FIG. 3;

FIG. 5 is a cross-sectional view of the hasp assembly of FIG. 3, taken along line 5-5 of FIG. 3;

FIG. 6 is a top, front, left side perspective view of a door hasp of the hasp assembly of FIG. 3;

FIG. 7 is a top, front, left side perspective view of a locker side hasp of the hasp assembly of FIG. 3;

FIG. 8 is a top, front, left side perspective view of a guard member of the hasp assembly of FIG. 3;

FIG. 9 is a top plan view of the guard member of FIG. 8;

FIG. 10 is a top, front, left side perspective view of the guard member and the door hasp of the hasp assembly of FIG. 3;

FIG. 11 is a front side elevation view of another hasp assembly according to the present technology; and

FIG. 12 is a bottom, front, right side perspective view of the hasp assembly of FIG. 11, shown in isolation.

It should be noted that the Figures may not be drawn to scale.

### DETAILED DESCRIPTION

The present detailed description is intended to be only a description of illustrative examples of the present technology. The following description relates to ways of manufacturing and designing a locker, a locker door assembly, and a hasp assembly for selectively securing a door. Other ways of manufacturing and designing the locker, the locker door assembly, and the hasp assembly are contemplated and this technology would encompass these other ways and designs.

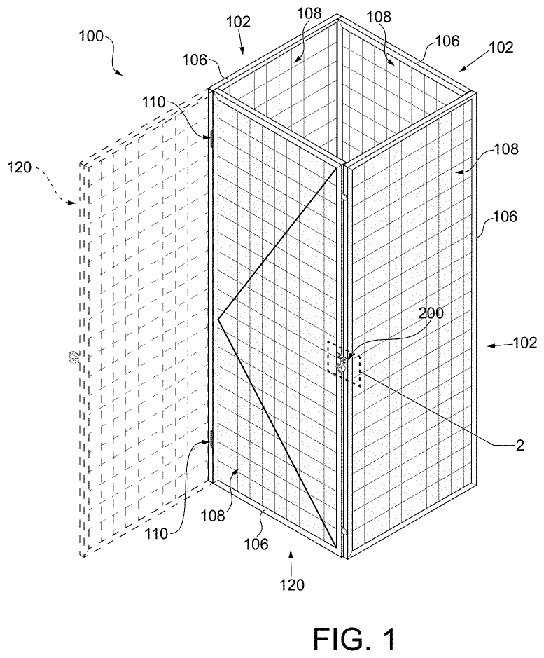

A locker 100 according to an embodiment of the present technology is illustrated in FIG. 1. The illustrated locker 100 is a stand-alone, mesh locker 100, but it is contemplated that the present technology could apply to different structures. These could include, but are not limited to: multiple door locker structures, cages, and partitions.

The locker 100 is constructed from a door 120 and three walls 102, specifically a right wall 102, a left wall 102, and a rear wall 102. In some embodiments, the walls 102 could be integrally connected as one U-shaped wall. In some other embodiments, the locker 100 could include more or fewer walls 102. In some embodiments, it is contemplated that the locker 100 could further include a roof and/or a floor. It is also contemplated that the locker 100 could have a different cross-sectional shape than that illustrated. The shape of the locker 100 could include, but is not limited to, rectangular, circular, round, etc.

Each of the walls 102 and the door 120 is constructed from a frame 106 and a mesh 108 connected to the frame 106. Each frame 106 is formed from a plurality of stainless steel angle bars welded together. Depending on the particular embodiment, it is contemplated that different structures could be utilized to form one or more of the frames 106. In some embodiments, one or more of the frames 106 could be made from one bar bent into a rectangle.

The mesh 108 is formed from rigid metal wires, spot welded together to form 2″ by 2″ (5.08 cm by 5.08 cm) squares, although this is not meant to be limiting. It is contemplated that different mesh materials and arrangements could be used. The mesh 108 is welded to the frame 106, although it is contemplated that the mesh 108 and the frame 106 could be connected together in a different manner It is also contemplated that one or more of the walls 102 and/or the door 120 could be solid or have a portion of the mesh 108 thereof replaced with a solid wall.

The door 120 is pivotably connected to the right wall 102, with a left edge of the door 120 being aligned with a front edge of the left wall 102 when the door 120 is in a closed position. The door 120 is pivotable between at least a fully open position (shown in dashed lines in FIG. 1), where the interior of the locker 100 is accessible, and the closed position, where the locker 100 is shut. The door 120 is also pivotable to any number of intervening positions.

In the illustrated locker 100, two hinges 110 connect a right edge of the door 120 to a front edge of the right wall 102. Depending on the particular arrangement, the door 120 could be pivotably connected to the left wall 102. It is also contemplated that the door 120 could be on a left or right side of the locker 100, such that the door 120 could connect to a front wall or the rear wall 102. It is further contemplated that the door 120 could be differently connected to the wall 102, for example via pivot brackets.

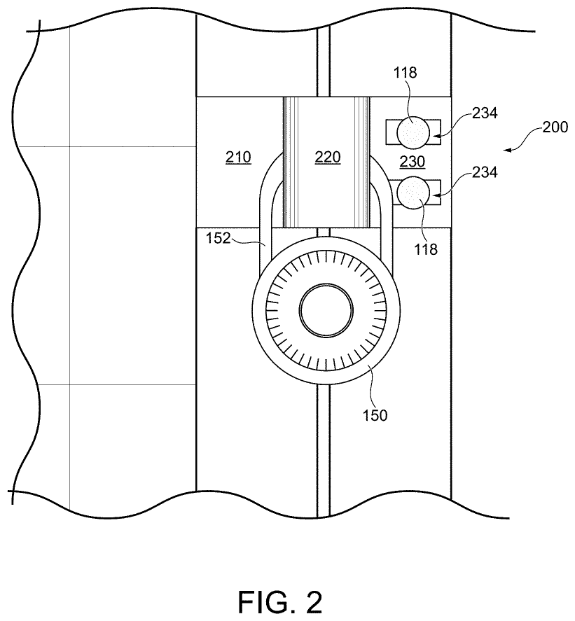

The locker 100 further includes a hasp assembly 200 for selectively securing the door 120 in the closed position to prevent access to the interior of the locker 100. As is illustrated in FIG. 1 and the close-up view thereof in FIG. 2, the hasp assembly 200 receives a combination lock 150 therethrough to secure the door 120 in the closed position to deter entry into the locker 100. The particular lock used is for illustrative purposes, and various different styles of lock could be used, including for instance a padlock.

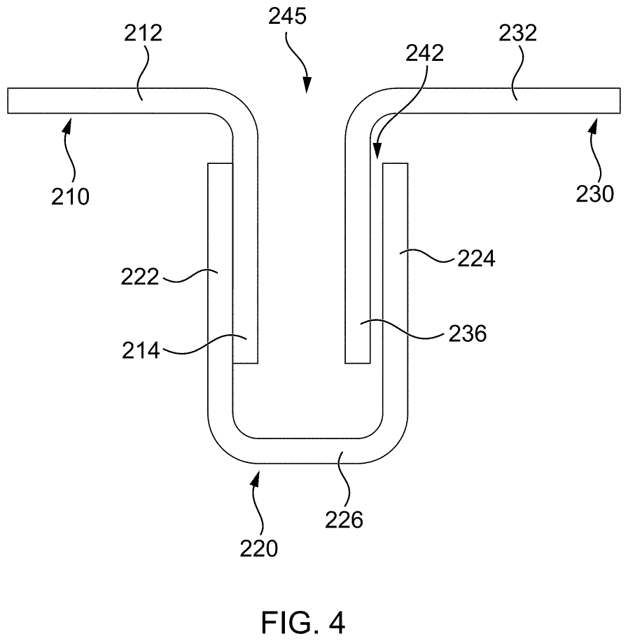

With reference to FIGS. 2 to 10, the hasp assembly 200 will now be described in more detail. The hasp assembly 200 is described herein as being connected, or adapted for being connected, to the locker 100 and/or the locker door 120, but it is contemplated that the hasp assembly 200 could be used for securing the door of a different type of structure. These could include, but are not limited to, sheds and cabinets.

The hasp assembly 200 includes a door hasp 210, a guard member 220, and a locker side hasp 230. In FIGS. 2 to 5, the components 210, 220, 230 are illustrated in their respective orientations when the door 120 is in the closed position. Generally, the door hasp 210 and the locker side hasp 230 are L-shaped hasps, disposed in a mirror-image arrangement, with the guard member 220 covering portions of the hasps 210, 230 and a forward side of the gap between them.

Each component 210, 220, 230 will be described in more detail separately, and the cooperation between the components 210, 220, 230 will be described thereafter.

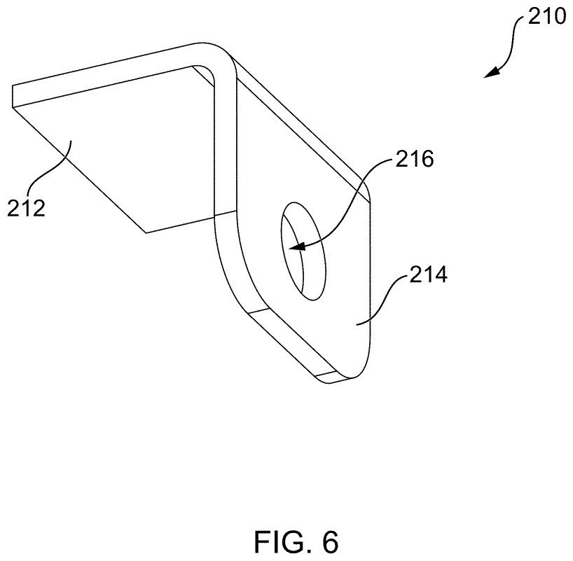

The door hasp 210, shown in isolation in FIG. 6, is connected to the door 120. More specifically, the door hasp 210 is welded to the door frame 106. In some embodiments, it is contemplated that the door hasp 210 could be differently connected to the door 120. For example, the door hasp 210 could be fastened, glued, or epoxied to the door 120, depending on the specifics of the embodiment.

The door hasp 210 includes a door connecting portion 212 that is welded to the door frame 106. Extending from the door connecting portion 212 is a forward portion 214, which extends forward and away from the locker 100 when the hasp 210 is connected to the door 120. The connecting portion 212 and the forward portion 214 form a general L-shape, although this may not always be the case. In some embodiments, for example, the forward portion 214 could extend from a central point of the connection portion 212, such that the hasp 210 has generally a T-shape.

While the intermediate section between the connecting portion 212 and the forward portion 214 is illustrated as smoothly curving, it is contemplated that the hasp 210 could have different forms between the two portions 212, 214. For example, the hasp 210 could have a sharp right-angle corner between the two portions 212, 214 in some embodiments.

The door hasp 210 defines an aperture 216. Specifically the aperture 216 is defined in the forward portion 214. The aperture 216 receives a shackle 152 of the combination lock 150 therethrough, as can be seen in FIG. 2. The aperture 216 could be sized and arranged to receive a shackle of a padlock or a different type of lock, as mentioned above.

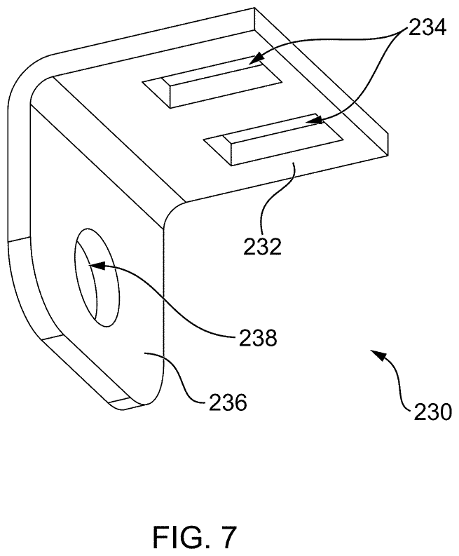

The locker side hasp 230 connected to the front side of the frame 106 of the left wall 102, as can be seen in FIGS. 1 and 2. The locker side hasp 230 is shown in isolation in FIG. 7.

The locker side hasp 230 is fastened to a surface adjacent the edge of the door 120. In the present embodiment, the adjacent surface is the exterior surface of the frame 106 of the adjacent side wall 102.

The locker side hasp 230 includes a wall connecting portion 232. The connection portion 232 defines two through-holes 234 for receiving fasteners therethrough. The connecting portion 232 is fastened to the wall 102 by two carriage bolts 118, illustrated in FIGS. 1 and 2. It is contemplated that different fasteners could be utilized, including but not limited to rivets and other types of bolts. As will be described in more detail below, the through-holes 234 are larger than the bolts 118 such that placement of the locker side hasp 230 can be adjusted for proper alignment with respect to the door hasp 210 and the guard member 220.

The locker side hasp 230 also includes a forward portion 236 which extends forward from the connecting portion 232. As with the door hasp 210, the locker side hasp 230 is generally L-shaped. The locker side hasp 230 is arranged in a mirror-image orientation to the door hasp 210.

When the door 120 is in the closed position, the forward portion 236 and the forward portion 214 of the door hasp 210 are parallel. The forward portions 214, 236, when the door 120 is in the closed position, are further generally aligned with each other and are separated by a gap 245. The gap 245 could be larger or smaller than illustrated in the Figures, depending on the particular embodiment or on the installation.

While the intermediate section between the connecting portion 232 and the forward portion 236 is illustrated as smoothly curving, it is contemplated that the hasp 230 could have different forms between the two portions 232, 236. For example, the hasp 230 could have a sharp right-angle corner between the two portions 232, 236 in some embodiments.

In some embodiments, it is contemplated that the door hasp 210 could be fastened to the door 120 and the locker side hasp 230 could be welded to the frame 106. Generally however, at least one of the door hasp 210 and the locker side hasp 230 is fastened (and not welded) to the locker 100, such that alignment adjustment can be made for any small misalignments between the door hasp 210 and the locker side hasp 230. It is contemplated however, that both hasps 210, 230 could be welded to their corresponding surfaces if another manner for adjustments is available.

The locker side hasp 230 defines an aperture 238. Specifically the aperture 238 is defined in the forward portion 236. The aperture 238 receives the shackle 152 of the combination lock 150 therethrough, as can be seen in FIG. 2. The aperture 238 could be sized and arranged to receive a shackle of a padlock or a different type of lock, as mentioned above.

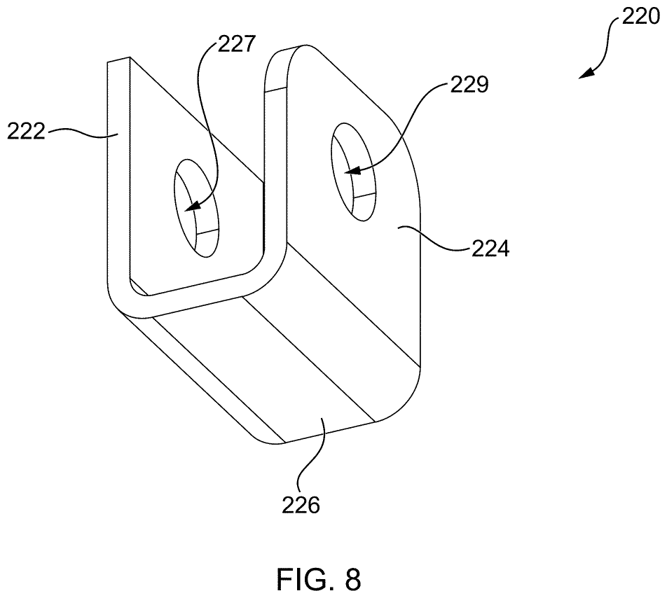

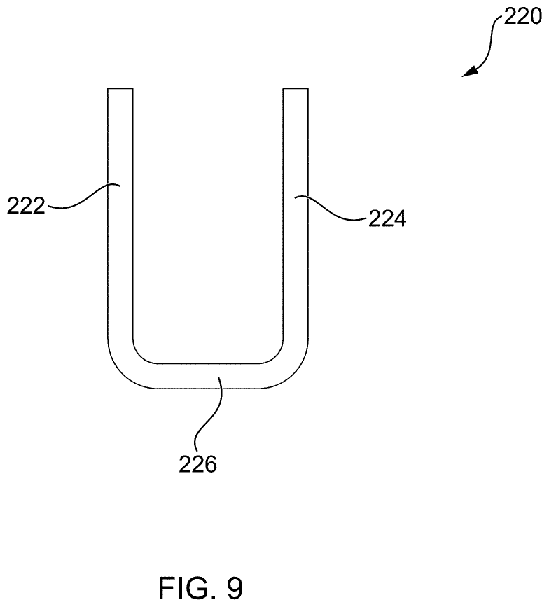

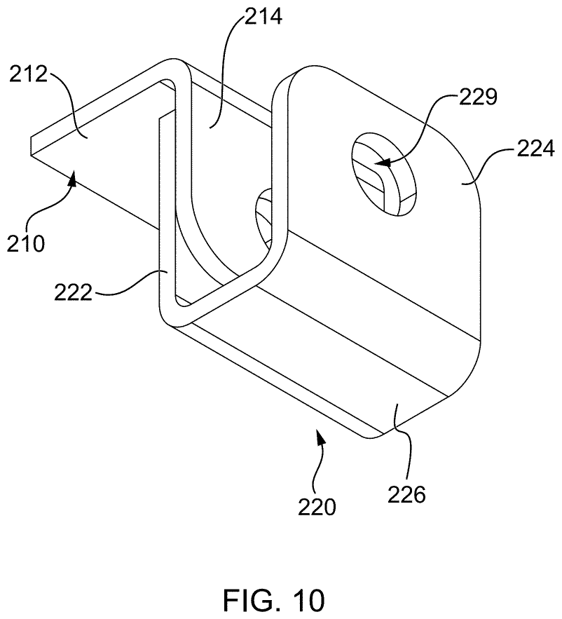

The guard member 220 is fixedly connected to the door hasp 210. The guard member 220 is shown in isolation in FIGS. 8 and 9. The guard member 220 is welded to the door hasp 210. It is contemplated that the guard member 220 could be glued, epoxied, or fastened to the door hasp 210, depending on specifics of any given embodiment. The assembly of the guard member 220 and the door hasp 210 is illustrated in FIG. 10.

The guard member 220 is generally U-shaped, with a door side portion 222, a locker side portion 224, and a central portion 226 extending between the side portions 222, 224. The central portion 226 as illustrated is generally flat with smoothly curving edges to join the side portions 222, 224, but different shapes are contemplated. For example, the central portion 226 could be more or less curved than illustrated.

The door side portion 222 of the guard member 220 extends along an exterior side of the forward portion 214. As illustrated, the door side portion 222 of the guard member 220 extends along the forward portion 214 nearly, but not all the way, to the connecting portion 212 of the door hasp 210. In some embodiments, however, the guard member 220 could cover more or less of the door hasp 210. The door side portion 222 lies flush with the portion 214, although it is contemplated that in some embodiments this may not be the case.

The guard member 220 defines an aperture 227 in the door side portion 222. The aperture 227 is aligned with the aperture 216 of the door hasp 210, although the apertures 227, 216 do not need to be perfectly aligned as will be described further below.

The locker side portion 224 of the guard member 220 extends along an exterior side of the forward portion 236 of the locker side hasp 230 when the door 120 is in the closed position. In contrast to the door side portion 222, there is a gap 242 between the locker side portion 224 and the forward portion 236. As can be seen in the Figures, a width of the gap 245 defined between the forward portions 214, 236 is greater than a width of the gap 242. The gap 242 is large enough to allow the guard member 220 to pivot around the locker side hasp 230 when the door 120 is opening and closing. It is contemplated that the gap 242 could be larger or smaller than illustrated. It is also contemplated that the relative sizes of the gaps 242, 245 could be different in different embodiments, or due to installation details.

As illustrated, the locker side portion 224 of the guard member 220 extends along the forward portion 236 nearly, but not all the way, to the connecting portion 232 of the locker side hasp 230. In some embodiments, however, the guard member 220 could cover more or less of the locker side hasp 230.

The locker side portion 224 of the guard member 220 defines an aperture 229. The aperture 229 is aligned with the aperture 238 of the locker side hasp 230 when the door 120 is in the closed position, although once again the apertures 229, 238 do not need to be perfectly aligned. The apertures 229, 238 are also generally aligned with the apertures 216 and 227, as will be further described below.

Each component 210, 220, 230 of the hasp assembly 200 is made from the same material and the same thickness of this material. In one example, 10 gauge stainless steel, which is cut, punched, and/or bent into shape by a programed computer numerical control (CNC) machine, is used. It is contemplated that the components 210, 220, 230 could be made from different materials, although all of the same thickness, including but not limited to: aluminum, galvanneal, and different gauges of stainless steel. It is also contemplated that the components 210, 220, 230 could be made in different thicknesses, either from the same or different materials.

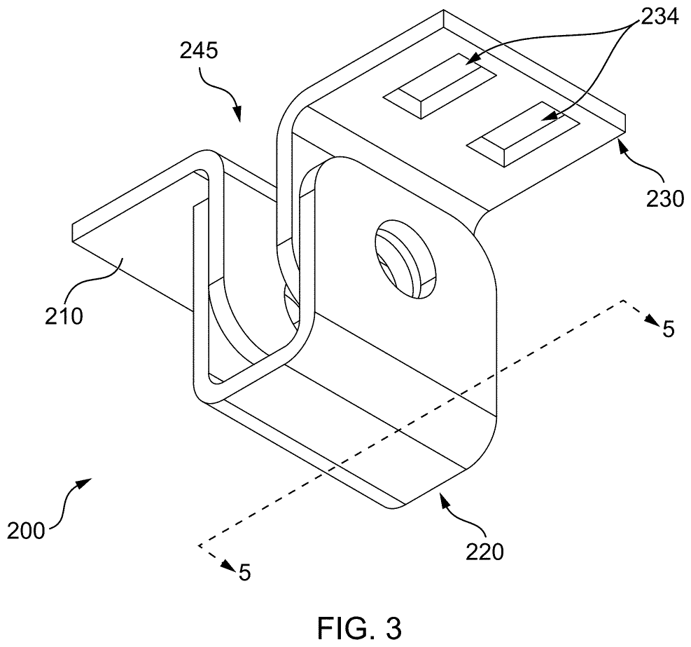

Cooperation of the different members 210, 220, 230 of the hasp assembly 200 will now be described in more detail. As is mentioned above and illustrated in FIG. 10, the guard member 220 overlaps and extends along a majority of the forward portion 214 of the door hasp 210. In some embodiments, the guard member 220 could cover more or less of the forward portion 214. When the door 120 is in the closed position, the guard member 220 further overlaps and extends along a majority of the forward portion 236 of the locker side hasp 230, as is illustrated in FIG. 3. It is contemplated that the guard member 220 could cover more or less of the forward portion 236 as well.

As can be seen in FIGS. 2 to 4, when the door 120 is closed the guard member 220 further extends around a forward side of the gap 245 between the forward portions 214, 236. The central portion 226 of the guard member 220 covers the gap 245, from the front side, so that the forward portions 214, 236 and a central portion of the shackle of the padlock is partially hidden by the guard member 220.

By extending along the forward portions 214, 236 and around the forward side of the gap 245, the guard member 220 covers portions of the hasps 210, 230 that could be vulnerable to interference. Further, because the guard member 220 and the hasps 210, 230 are made from the same material, the overlapping of the guard member 220 creates a double thickness of the steel where the hasp assembly 200 extends forward from door 120 and the wall 102.

As described above and illustrated in FIGS. 1 and 2, each of the components 210, 220, 230 define apertures 216, 227, 229, 238 that receive the combination lock 150 therethrough. Depending on the specific embodiment of the locker 100 or the hasp assembly 200, the apertures 216, 227, 229, 238 may be adapted to different sizes of locks. For example, the hasp assembly 200 adapted for a residential locker may have smaller apertures 216, 227, 229, 238 to receive a smaller, simpler lock than, for example, another embodiment of the hasp assembly 200 adapted for an industrial locker.

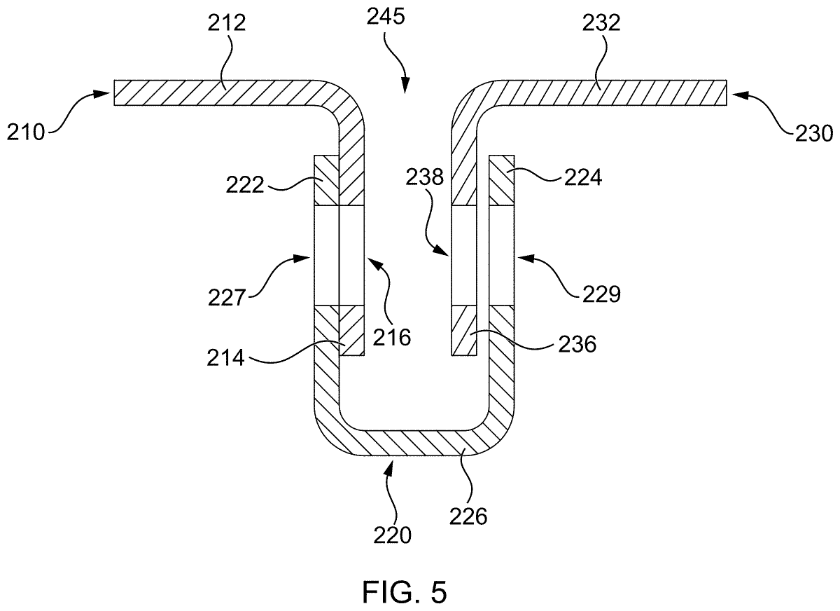

In order to allow the shackle to pass through the hasp assembly 200 to lock the locker door 120 in the closed position, the apertures 216, 227, 229, 238 are aligned, as can be seen in FIG. 5. It is contemplated that the apertures 216, 227, 229, 238 could be only partially aligned, as there may be some slight misalignment depending on particulars of a particular embodiment or a particular installation.

As mentioned above, the apertures 216, 227, 229, 238 need not be perfectly aligned, provided that the overlapping area between the apertures 216, 227, 229, 238 is sufficient to readily accept the shackle from a user's lock. As can be seen in FIG. 2, the through-holes 234 are larger than the bolts 118 such that placement of the locker side hasp 230 can be adjusted for proper alignment with respect to the door hasp 210 and the guard member 220, in order to aid in the alignment of the apertures 229, 238.

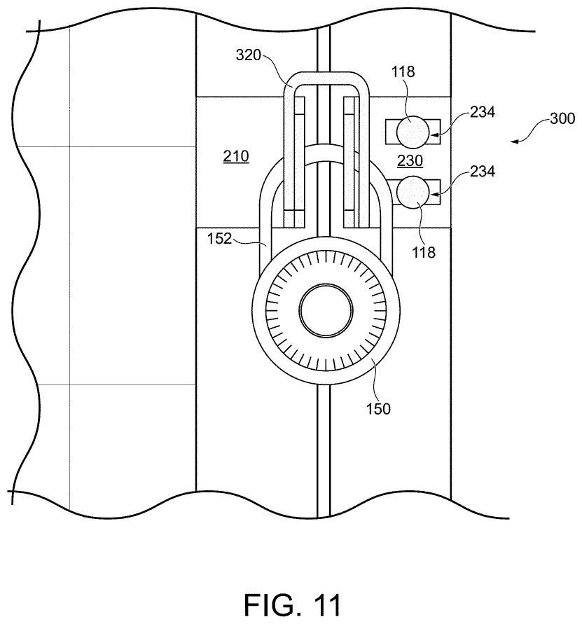

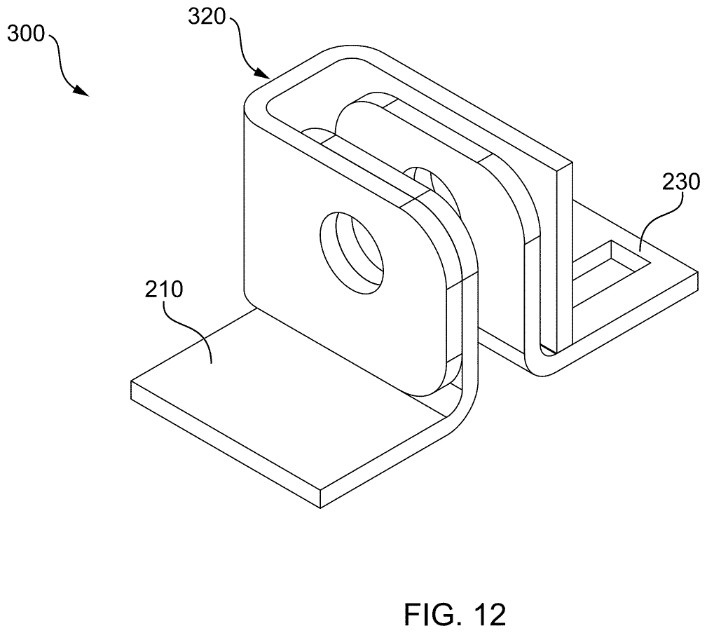

With reference to FIGS. 11 and 12, another non-limiting embodiment of a hasp assembly 300 according to the present technology is presented. Elements of the assembly 300 that are similar to those of the assembly 200 retain the same reference numeral.

The hasp assembly 300 includes a guard member 320 connected to the door hasp 210. In this embodiment, the guard member 320 extends over a top side of the gap 245 between the hasps 210, 230, rather than around the front side. The guard member 320 still extends along the forward portions of the hasps 210, 230. As such the hasp assembly 300 has a double thickness along the forward portions 214, 236, similarly to the hasp assembly 200. In this embodiment, however, a top side of the gap 245 and a lock shackle are covered by the guard member 320, rather than the front side as is the case with guard member 220.

It is also contemplated that the guard member 320 could be oriented in the mirror-image orientation, such that the guard member 320 extends around a bottom side of the gap between the hasps 210, 230.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A hasp assembly for selectively securing a door, the hasp assembly comprising:
a first hasp adapted to connect to the door, the first hasp defining a first hasp aperture;
a second hasp adapted to connect to a surface adjacent the door, the second hasp defining a second hasp aperture; and
a guard member fixedly connected to the first hasp, the guard member defining a first guard aperture and a second guard aperture, the first guard aperture and the first hasp aperture being at least partially aligned, the guard member extending along at least a portion of an exterior side of the first hasp,
the first hasp aperture, the second hasp aperture, the first guard aperture, and the second guard aperture being at least partially aligned for receiving a locking apparatus therethrough when the hasp assembly is installed and the door is in a closed position,
the guard member extending at least partially over a first portion of the first hasp defining the first hasp aperture and a second portion of the second hasp defining the second hasp aperture when the hasp assembly is installed and the door is in the closed position.

2. The hasp assembly of claim 1, wherein:
the first hasp and the second hasp are L-shaped hasps; and
the first and second hasps are disposed in mirror-image arrangements.

3. The hasp assembly of claim 2, wherein:
the first hasp further includes a third portion adapted to connect to the door, the first portion extending forward from the third portion; and
the second hasp further includes a fourth portion adapted to connect to the surface, the second portion extending forward from the fourth portion,
the first portion and the second portion being generally parallel when the hasp assembly is installed and the door is in the closed position.

4. The hasp assembly of claim 3, wherein, when the door is in the closed position, the guard member extends:
along at least a majority of an exterior side of the first portion;
around a forward side of a gap between the first portion and the second portion; and
along at least a majority of an exterior side of the second portion.

5. The hasp assembly of claim 3, wherein, when the door is in the closed position, the guard member extends:
along at least a majority of an exterior side of the first portion;
over a top side of a gap between the first portion and the second portion; and
along at least a majority of an exterior side of the second portion.

6. The hasp assembly of claim 1, wherein the first hasp, the second hasp, and the guard member are made of a same material.

7. The hasp assembly of claim 1, wherein the first hasp, the second hasp, and the guard member are made from material having a same thickness.

8. The hasp assembly of claim 1, wherein the guard member is welded to the first hasp.

9. The hasp assembly of claim 1, wherein:
the guard member is generally U-shaped;
straight portions of the U-shape overlap the first and second hasps when the hasp assembly is installed and the door is in the closed position; and
a central portion of the U-shape covers a gap between the first hasp and the second hasp when the hasp assembly is installed and the door is in the closed position.

10. The hasp assembly of claim 1, wherein a width of a first gap defined between the first portion and the second portion is greater than a width of a second gap defined between the second portion and a portion of the guard member overlapping the second portion when the door is closed.

11. A locker door assembly for installing on a locker, the locker door assembly comprising:
a door selectively moveable between at least a closed position and an opened position; and
a hasp assembly for selectively securing the door in the closed position, the hasp assembly comprising:
a first hasp connected to the door, the first hasp defining a first hasp aperture;
a second hasp adapted to connect to a surface adjacent the door, the second hasp defining a second hasp aperture; and
a guard member fixedly connected to the first hasp, the guard member defining a first guard aperture and a second guard aperture, the first guard aperture and the first hasp aperture being at least partially aligned, the guard member extending along at least a portion of an exterior side of the first hasp,
the first hasp aperture, the second hasp aperture, the first guard aperture, and the second guard aperture being at least partially aligned for receiving a locking apparatus therethrough when the hasp assembly is installed and the door is in a closed position,
the guard member extending at least partially over a first portion of the first hasp defining the first hasp aperture and a second portion of the second hasp defining the second hasp aperture when the hasp assembly is installed and the door is in the closed position.

12. The locker door assembly of claim 11, wherein:
the first hasp is welded to the door; and
the second hasp is adapted to be bolted to the surface.

13. The locker door assembly of claim 11, wherein:
the guard member is generally U-shaped;
straight portions of the U-shape overlap the first and second hasps when the hasp assembly is installed and the door is in the closed position; and
a central portion of the U-shape covers a gap between the first hasp and the second hasp when the hasp assembly is installed and the door is in the closed position.

14. A locker comprising:
a plurality of walls;
a door pivotably connected to a wall of the plurality of walls, the door being selectively moveable between at least a closed position and an opened position; and
a hasp assembly for selectively securing the door in the closed position, the hasp assembly comprising:
a first hasp connected to the door, the first hasp defining a first hasp aperture;
a second hasp connected to a surface of the locker adjacent the door, the second hasp defining a second hasp aperture; and
a guard member fixedly connected to the first hasp, the guard member defining a first guard aperture and a second guard aperture, the first guard aperture and the first hasp aperture being at least partially aligned, the guard member extending along at least a portion of an exterior side of the first hasp,
the first hasp aperture, the second hasp aperture, the first guard aperture, and the second guard aperture being at least partially aligned for receiving a locking apparatus therethrough when the door is in a closed position,
the guard member extending at least partially over a first portion of the first hasp defining the first hasp aperture and a second portion of the second hasp defining the second hasp aperture when the door is in the closed position.

15. The locker of claim 14, wherein:
the first hasp is welded to the door;
the guard member is welded to the first hasp; and
the second hasp is bolted to the surface of the locker adjacent the door.

16. The locker of claim 14, wherein:
the first hasp further includes a third portion connected to the door, the first portion extending forward from the third portion; and
the second hasp further includes a fourth portion connected to the surface of the locker adjacent the door, the second portion extending forward from the fourth portion,
the first portion and the second portion being generally parallel when the door is in the closed position.

17. The locker of claim 16, wherein, when the door is in the closed position, the guard member extends:
along at least a majority of an exterior side of the first portion;
around a forward side of a gap between the first portion and the second portion; and
along at least a majority of an exterior side of the second portion.

18. The locker of claim 16, wherein, when the door is in the closed position, the guard member extends:
along at least a majority of an exterior side of the first portion;
over a top side of a gap between the first portion and the second portion; and
along at least a majority of an exterior side of the second portion.

19. The locker of claim 14, wherein:
the door includes:
a door frame, and
mesh material connected to the door frame;
the wall of the plurality of walls includes:
a wall frame including the surface of the locker adjacent the door, and
mesh material connected to the wall frame;
the first hasp is connected to the door frame; and
the second hasp is connected to the wall frame.

20. The locker of claim 14, wherein:
the guard member is generally U-shaped;
straight portions of the U-shape overlap the first and second hasps when the door is in the closed position; and
a central portion of the U-shape covers a gap between the first hasp and the second hasp when the door is in the closed position.
